(19) United States
(12) Patent Application Publication
(10) Pub. No.: US 2003/0036836 A1
(43) Pub. Date: Feb. 20, 2003

(54) Method of protecting a control unit of a motor vehicle from manipulation

(76) Inventor: Norbert Miller, Stuttgart (DE)

Correspondence Address: KENYON & KENYON, ONE BROADWAY, NEW YORK, NY, 10004, US

(21) Appl. No.: 10/187,654

(22) Filed: Jul. 1, 2002

(30) Foreign Application Priority Data
Jul. 2, 2001 (DE) 101 31 573.2

(51) Int. Cl. G06F 19/00

(52) U.S. Cl. 701/54; 701/51

(57) ABSTRACT

A method of protecting a control unit of a motor vehicle from manipulation. The control unit is used for the control and/or regulation of the functions of a motor vehicle as a function of at least one operating variable of the motor vehicle. The method is used to protect at least one of the operating variables from manipulation. To prevent a manipulation of the operating variables, the at least one of the operating variables is subjected to a plausibility test using at least one other operating variable of the motor vehicle during operation of the motor vehicle. In particular, a speed signal is subjected to the plausibility test using a rotational speed signal of an internal combustion engine of the motor vehicle and an instantaneous gear ratio of a transmission of the motor vehicle.

### FIELD OF THE INVENTION

The present invention relates to a method of protecting a control unit of a motor vehicle from manipulation. The control unit is used for the control and/or regulation of the functions of a motor vehicle as a function of at least one operating variable of the motor vehicle. The method serves to protect the control unit from the manipulation of at least one of the operating variables.

The present invention further relates to a memory element for a control unit of a motor vehicle for the control and/or regulation of the functions of a motor vehicle. A computer program that is executable on a computing element of the control unit, in particular on a microprocessor, is stored on the memory element. The memory element is embodied, for example, as a read-only memory, as a random-access memory, or as a flash memory.

The present invention also relates to a computer program that is executable on a computing element of a control unit, in particular on a microprocessor.

Finally, the present invention also relates to a control unit of a motor vehicle for the control and/or regulation of the functions of the motor vehicle as a function of at least one operating variable of the motor vehicle. The control unit includes an arrangement for protecting the control unit from manipulation.

### BACKGROUND INFORMATION

Other prior systems may involve limiting the maximum allowable top speed by storing a threshold value for the maximum allowable top speed in a memory arrangement of the motor vehicle and, during operation of the motor vehicle, performing a comparison between the current speed signal and the threshold value. If the speed signal exceeds the threshold value, appropriate countermeasures are initiated in order to reduce the speed of the motor vehicle. Such countermeasures include, for example, changing the ignition and/or fuel supply in an internal combustion engine having spark ignition and changing the time of fuel supply and the amount of fuel supplied in a self-igniting internal combustion engine.

Unauthorized third parties may circumvent the maximum allowable top speed by manipulating the speed signal in such a manner that it always remains below the threshold value. The speed signal may never exceed the threshold value in the control unit, and an actual speed of the motor vehicle above the threshold value may never be detected. In this manner, a motor vehicle with sufficient power may exceed an originally established maximum allowable top speed.

### SUMMARY OF THE INVENTION

It is an object of the exemplary embodiment and/or exemplary method of the present invention to prevent the manipulation of operating variables that are supplied to the control unit of a motor vehicle.

The exemplary embodiment and/or exemplary method of the present invention suggests attaining this object by subjecting at least one of the operating variables to a plausibility test using at least one other operating variable of the motor vehicle during operation of the motor vehicle.

Therefore, according to the exemplary embodiment and/or exemplary method of the present invention, the operating variables are not used indiscriminately for achieving control and/or regulation of the functions of a motor vehicle. Rather, they are first subjected to a plausibility test. In order to test the plausibility of the at least one operating variable, further operating variables are used. In a motor vehicle, there is a plurality of more or less complicated relationships between various operating variables. Thus, for example, it is conceivable to check the plausibility of the signal of a transverse acceleration sensor using the signal of a steering angle sensor. Similar relationships that may be used for a plausibility test exist, for example, between the vehicle speed, the braking force, the torque produced by the internal combustion engine, and the signal of a longitudinal acceleration sensor. The plausibility test is performed in an ongoing manner during the operation of the motor vehicle at time intervals that may be predetermined.

The exemplary embodiment and/or exemplary method of the present invention includes checking received signals of a control unit of a motor vehicle that are used for the control and/or regulation of the functions of a motor vehicle for plausibility in order to prevent a manipulation of the control and/or regulation function of the control unit by entering received signals that have been manipulated. In this manner, an altered effect or even a defect of the controlled or regulated function may be prevented. Moreover, the detection of a manipulated input signal may be used in the case of damage for the purpose of determining warranty claims.

According to an exemplary embodiment and/or exemplary method of the present invention, a speed signal is subjected to a plausibility test using a rotational speed signal of an internal combustion engine of the motor vehicle and an instantaneous gear ratio of a transmission of the motor vehicle during operation of the motor vehicle. In the context of the exemplary embodiment and/or exemplary method of the present invention, gear ratio shall also be understood to include a “less than 1” gear ratio, i.e., a reduction ratio. According to this development, the exemplary embodiment and/or exemplary method of the present invention is therefore used for detecting the manipulation of a speed signal. In this manner, a motor vehicle may be prevented from being driven above the maximum allowable top speed. A fixed relationship exists between the vehicle speed, the rotational speed of the engine, and the gear ratio of the transmission. If two of these values are known, the third value may be calculated with a high degree of precision. Using the rotational speed of the engine and the gear ratio, a manipulation of the speed signal may be detected with a high degree of reliability.

According to an exemplary embodiment and/or exemplary method of the present invention, the instantaneous gear ratio is calculated from application data in which the gear ratio for the speeds of the transmission are stored using a transmission speed that has been presently selected. According to this exemplary embodiment, therefore, the presently selected transmission speed in a manual transmission or an automatic transmission is detected and the gear ratio corresponding to the selected transmission speed is calculated based on application data stored in a program memory of the control unit.

If the transmission includes a transmission control unit, as is the case in automatic transmissions, for example, the current gear ratio is transmitted from the transmission control unit to the control unit for the control and/or regulation of the functions of the motor vehicle. The transmission control unit may also transmit the selected gear or output speed to the control unit and the control unit may calculate the gear ratio from the selected gear using the application data.

In an automatic transmission, the instantaneous gear ratio is calculated taking into account a converter slip. The plausibility test is therefore also performed as a function of a torque converter lockup clutch.

The implementation of the exemplary method according to the present invention in the form of a memory element that is provided for a control unit of a motor vehicle for the control and/or regulation of motor vehicle functions is particularly significant. Here, a computer program that is executable on a computing element of the control unit, in particular on a microprocessor, is stored on the memory element and is appropriate for performing the exemplary method according to the present invention. In this case, therefore, the exemplary method of the present invention is implemented via a computer program stored on the memory element such that this program represents the present invention in the same manner as the method which the computer program is suited to perform. In particular, an electric memory element may be used as the memory element, for example, a read-only memory, a random-access memory, or a flash memory.

The exemplary embodiment and/or exemplary method of the present invention also relates to a computer program that is appropriate for performing the exemplary method according to the exemplary embodiment and/or exemplary method of the present invention when it is executed on a computing element of a control unit, in particular a microprocessor. Here, the computer program is stored in a memory element, in particular in a flash memory.

Based on the control unit of the type mentioned at the outset, the control unit includes a testing arrangement for performing a plausibility test of at least one of the operating variables, with the testing arrangement performing the plausibility test using at least one other operating variable of the motor vehicle during operation of the motor vehicle.

According to an exemplary embodiment of the present invention, the control unit is used to control and/or regulate an internal combustion engine of the motor vehicle as a function of the speed of the motor vehicle, with the testing arrangement performing a plausibility test of a speed signal using a rotational speed signal of the internal combustion engine and a gear ratio of a transmission of the motor vehicle.

According to an exemplary embodiment of the present invention, the control unit controls the internal combustion engine as a function of the ignition time, the ignition angle, the fuel injection time, and/or amount of fuel injected in such a manner that the speed of the motor vehicle decreases if the speed signal exceeds a preselectable threshold value for the maximum allowable top speed of the motor vehicle.

### BRIEF DESCRIPTION OF THE DRAWINGS

FIG. 1 shows a control unit according to an exemplary embodiment of the present invention.

FIG. 2 shows a flow chart of an exemplary method according to the present invention.

### DETAILED DESCRIPTION

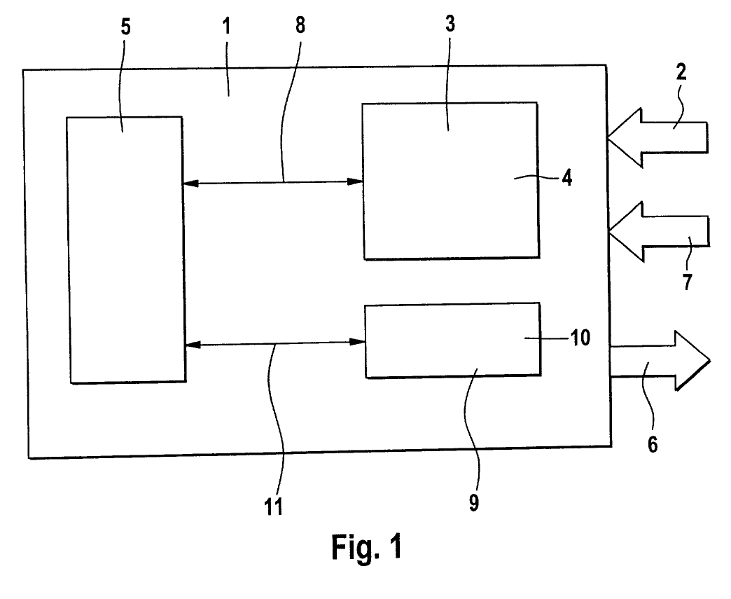

In FIG. 1, a control unit for a motor vehicle is indicated in its entirety by the reference number 1. Control unit 1 is used to control and/or regulate any desired functions of a motor vehicle, for example, an internal combustion engine, an anti-lock braking system (ABS), the electronic stability program of the motor vehicle, an electronic steering assembly (steer-by-wire), an electronic brake (brake-by-wire), or any desired comfort function in the motor vehicle. The control and/or regulation of the functions of the motor vehicle occurs as a function of at least one operating variable 2 of the motor vehicle. The type of operating variable 2 is dependent upon the type of the function to be regulated and/or controlled.

Control unit 1 includes a memory arrangement 3 which is configured, for example, as a re-writable memory device, in particular as a flash memory. Control program 4, among other things, is stored in memory arrangement 3. Control program 4 is executable on computing device 5 which is configured, for example, as a microprocessor. Data transfer port 8 is provided between memory arrangement 3 and computing device 5 for the purpose of transferring control program 4 to computing device 5. The control and/or regulation function of control unit 1 is implemented by the execution of control program 4 on computing device 5. In the course of the control and/or regulation of the function, control unit 1 produces trigger signals 6 for the desired components of the motor vehicle, the function of the motor vehicle to be controlled and/or regulated is influenced by the triggering of the components via trigger signals 6.

If control unit 1 is used, for example, for the purpose of monitoring the speed of a motor vehicle so that the motor vehicle may not exceed a maximum allowable top speed, a signal of a speed measuring device that contains information about current speed V_actual of the motor vehicle is used as an operating variable. In control unit 1, speed signal V_actual is compared to threshold value V_max for the maximum allowable top speed stored therein.

If current speed V_actual exceeds maximum speed V_max, trigger signals 6 are produced for an internal combustion engine of the motor vehicle. Trigger signals 6 are, for example, the ignition time, the ignition angle, the fuel injection time, and/or the amount of fuel injected. When the internal combustion engine is triggered by trigger signals 6, speed V_actual of the motor vehicle decreases. The triggering of the internal combustion engine using trigger signals 6 occurs until speed V_actual again lies below maximum speed V_max.

Speed signal V_actual may be manipulated by unauthorized third parties in such a manner that signal V_actual never reaches maximum speed V_max. In the most simple case, speed signal V_actual may simply be multiplied by ½ or another factor less than 1. Unauthorized third parties use this manipulatability to circumvent a limitation of the maximum top speed of a motor vehicle to V_max. This manner of manipulation is particularly of interest for high-performance motor vehicles that are limited in the factory to a maximum speed V_max that may be preset, for example, at 250 km/h.

The exemplary method according to the present invention prevents such a manipulation of operating variables 2 that are provided to control unit 1 of a motor vehicle for the control and/or regulation of the functions of the motor vehicle. This includes checking at least one of operating variables 2 for plausibility using another operating variable 7 of the motor vehicle during operation of the motor vehicle. In particular, those operating variables 2 are checked that are used for the control and/or regulation of the function of the motor vehicle.

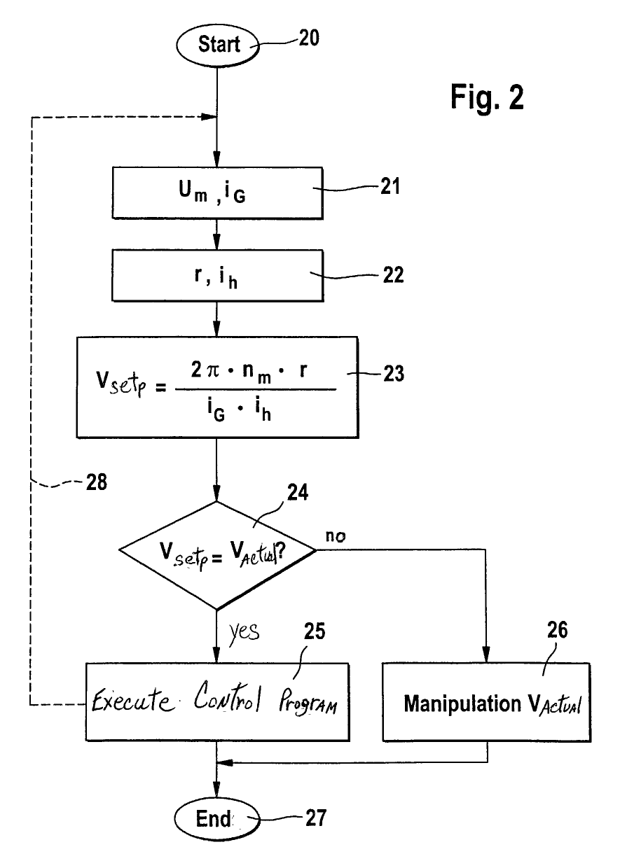

The exemplary method according to the present invention shall be described in greater detail for the exemplary embodiment described above with reference to FIG. 2. Speed signal V_actual is subjected to a plausibility test as operating variable 2. A rotational speed signal n_m of the internal combustion engine of the motor vehicle and an instantaneous gear ratio i_G of a transmission of the motor vehicle are then used as other operating variables 7. Instantaneous gear ratio i_G may be calculated, for example, from application data using a gear speed that has been presently selected. However, gear ratio i_G may also be transmitted from a transmission control unit to control unit 1 for the control and/or regulation of the functions of a motor vehicle. In the case of an automatic transmission, gear ratio i_G is calculated while taking into account a converter slip.

The method begins in function block 20. The instantaneous values of the other operating variables 7 are input into function block 21. Particular parameter values, which are also needed for the plausibility test, are input into function block 22. These parameter values are predetermined in a fixed manner for the respective motor vehicle. In the present case, the parameter values are radius r of the tires mounted on the motor vehicle and axle gear ratio i_h. A typical value for radius r of a tire is 0.33 m, for example. In the case of mass-produced vehicles, axle gear ratio i_h generally lies between 2.2 and 5.0. In the following, an axle gear ratio i_h of 4.0 is assumed.

$$V \_ s e tp = \frac{2 \cdot π \cdot r \cdot n \_ m}{i \_ G \cdot i \_ h} = \frac{2 \cdot π \cdot \frac{5000}{60} \cdot 0.33}{0.8 \cdot 4.0} = 54 \frac{m}{s} {=}^{\hat{}} 194.4 \frac{km}{h}$$

Speed V_setup of the motor vehicle is calculated in function block 23 as a function of the other operating variables 7 and the parameter values. In the case of an instantaneous rotational speed of the engine of 5,000 rpm and a gear ratio of 0.8 (in fifth gear), the following results:

In query block 24, it is tested whether calculated speed V_setup is equal to speed V_actual of the input speed signal. If so, the plausibility test was successful and the control program may be executed in a normal manner using speed signal V_actual (function block 25). The plausibility test may be repeated from time to time. For this purpose, a line is shown branching off from function block 25 to function block 21 (dashed line 28). When the execution of control program 4 is complete, the branch from function block 25 to function block 27 is followed, where the method is terminated.

However, if calculated speed V_setup is not equal to speed V_actual, then the plausibility test was not successful, and a manipulation of speed signal V_actual is assumed (function block 26). In this case, appropriate countermeasures are taken. For example, an immediate disabling of control unit 1, a disabling of control unit 1 at the next driving cycle, or the storage of manipulation information in a maintenance memory of the motor vehicle that will be read the next time the motor vehicle is at the repair shop is conceivable.

For the purpose of performing the exemplary method according to the present invention, computer program 10, which is also executable on computing unit 5, is stored in memory element 9 of control unit 1. Data transfer connection 11 is provided between memory element 9 and computing element 5. Memory element 9 may be embodied as a flash memory. Therefore, before operating variables 2 are used by control program 4 for the control and/or regulation of the functions of the motor vehicle, they are checked for plausibility by computer program 10 using other operating variables 7.

What is claimed is:

1. A method for protecting a control unit of a motor vehicle from manipulation, the method comprising:
subjecting at least one operating variable of the motor vehicle to a plausibility test using at least one other operating variable of the motor vehicle during operation of the motor vehicle to protect the at least one operating variable from manipulation; and
controlling at least one function of the motor vehicle via the control unit as a function of the at least one operating variable of the motor vehicle.

2. The method of claim 1, wherein a speed signal is subjected to the plausibility test using a rotational speed signal of an internal combustion engine of the motor vehicle and an instantaneous gear ratio of a transmission of the motor vehicle during operation of the motor vehicle.

3. The method of claim 2, wherein the instantaneous gear ratio is calculated from application data that stores at least one gear ratio for at least one speed of the transmission with reference to a selected transmission speed.

4. The method of claim 2, wherein the instantaneous gear ratio is transmittable from a transmission control unit to the control unit for controlling the at least one function of the motor vehicle.

5. The method of claim 3, wherein the instantaneous gear ratio is calculated taking into account a converter slip of an automatic transmission.

6. A memory element for a control unit of a motor vehicle for at least one of controlling and regulating at least one function of the motor vehicle, comprising:
a computer program stored at the memory element and executable by a computer of the control unit, wherein the computer program includes program code for protecting the control unit from manipulation in accordance with a method, the method including:
subjecting at least one operating variable of the motor vehicle to a plausibility test using at least one other operating variable of the motor vehicle during operation of the motor vehicle to protect the at least one operating variable from manipulation; and
controlling the at least one function of the motor vehicle via the control unit as a function of the at least one operating variable of the motor vehicle.

7. The memory element of claim 6, wherein the memory element is one of a read-only memory, a random-access memory and a flash memory.

8. The memory element of claim 6, wherein the computer is a microprocessor.

9. A computer program storable at a memory and executable by a computer, the computer program including program code for protecting a control unit of a motor vehicle from manipulation in accordance with a method, the method including:
subjecting at least one operating variable of the motor vehicle to a plausibility test using at least one other operating variable of the motor vehicle during operation of the motor vehicle to protect the at least one operating variable from manipulation; and
controlling at least one function of the motor vehicle via the control unit as a function of the at least one operating variable of the motor vehicle.

10. The computer program of claim 9, wherein the computer is a microprocessor

11. The computer program of claim 9, wherein the memory is a flash memory.

12. A control unit of a motor vehicle for controlling at least one function of the motor vehicle as a function of at least one operating variable of the motor vehicle, the control unit comprising:
a protecting arrangement to protect the control unit from manipulation by performing a plausibility test of the at least one operating variable using at least one other operating variable of the motor vehicle during operation of the motor vehicle.

13. The control unit of claim 12, wherein the control unit controls an internal combustion engine of the motor vehicle as a function of a speed of the motor vehicle, and the protecting arrangement performs the plausibility test of a speed signal using a rotational speed signal of the internal combustion engine and an instantaneous gear ratio of a transmission of the motor vehicle.

14. The control unit of claim 13, wherein the control unit controls the internal combustion engine using at least one of an ignition time, an ignition angle, a fuel injection time, and an amount of fuel injected in such a manner that the speed of the motor vehicle decreases if the speed signal exceeds a preselectable threshold value for a maximum allowable speed of the motor vehicle.
